(19) United States
(12) Patent Application Publication
(10) Pub. No.: US 2008/0160824 A1
(43) Pub. Date: Jul. 3, 2008

(54) ELECTRIC WIRE PROTECTOR

(75) Inventors: Te-Sheng LIU, Taichung City (TW); Chien-Ming Hu, Tainan County (TW); Ying-Chih Shen, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: Universal Scientific industrial Co., Ltd., Nan Tou (TW)

(21) Appl. No.: 11/751,271

(22) Filed: May 21, 2007

(30) Foreign Application Priority Data
Dec. 29, 2006 (TW) 95223253

(51) Int. Cl. H01R 13/58

(52) U.S. Cl. 439/456

(57) ABSTRACT

An electric wire protector installed in a connector to protect the electric wires is disclosed. The electric wire protector has a body provided with an accommodation chamber for accommodating the connector, a top disposed at a top side of the body for protecting the electric wires, and clamping portions extended from a lower side of the body for clamping on the connector to secure the body to the connector.

### BACKGROUND OF THE INVENTION

1. Field of the Invention

The present invention relates to an electric wire protector and more particularly, to such an electric wire protector specifically designed for installation in a connector to protect the electric wires.

2. Description of the Related Art

Referring to FIG. 1, during installation of the hardware of an electronic implement (such as computer, audio system, etc.), a connector 1 will be used with electric wires 2 for electric connection to transmit signal or to provide power supply. Because it is the market trend to provide electronic implements having thin and small characteristics, the inside space of the housing 3 of an electronic implement having thin and small characteristics is limited, and the housing 3 may interfere with the installation of electric wires 2. In this case, installed electric wires 2 will be oppressed or forced to curve inside the housing 3. When an external force oppress the electric wires 2, the electric wires 2 will be stretched, and the stretching force may cause a contact error between the pins of the associated connector 1 and the connector 6 of the circuit board 5, resulting in a short circuit or spark.

In general, a conventional electric wire installation structure tends to cause contact carbonization, resulting in a short circuit or spark. An explosion may occur when a short circuit or spark is occurred in a place full of inflammable gas. Therefore, this conventional electric wire installation structure is not safe and must be improved.

### SUMMARY OF THE INVENTION

The present invention has been accomplished under the circumstances in view. It is the main object of the present invention to provide an electric wire protector, which effectively supports and protects electric wires, assuring safety use of the electric wires.

To achieve this and other objects of the present invention, the electric wire protector is capped on a connector to protect at least one electric wire. The electric wire protector comprises a body, which defines an accommodation chamber for accommodating the connector and for the passing of the at least one electric wire, a top disposed at a top side of the body for protecting the electric wire, and at least one clamping portion extended from a lower side of the body for clamping on the connector to secure the body to the connector.

### BRIEF DESCRIPTION OF THE DRAWINGS

FIG. 1 illustrates structure of electric wires inside the housing of an electronic implement according to a prior art.

FIG. 2 is an elevational view of an electric wire protector according to the present invention.

FIG. 3 is a schematic drawing showing the installation of the electric wire protector in a connector according to the present invention.

FIG. 4 is a perspective view of the electric wire protector and the connector according to the present invention, showing the engagement of the limiter and clamping portions.

FIG. 5 corresponds to FIG. 3 when viewed from another angle.

FIG. 6 corresponds to FIG. 4 when viewed from another angle.

FIG. 7 is a schematic view showing the electric wire protector installed in a connector inside an electronic implement's housing.

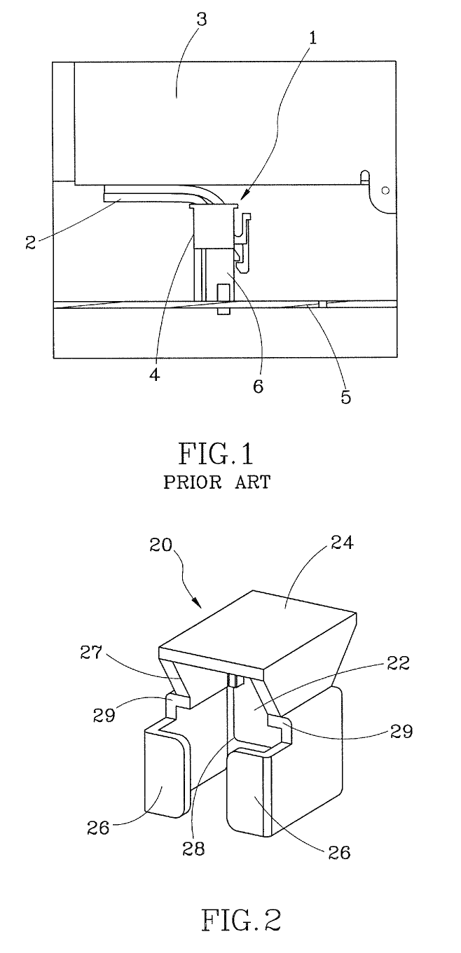

### DETAILED DESCRIPTION OF THE INVENTION

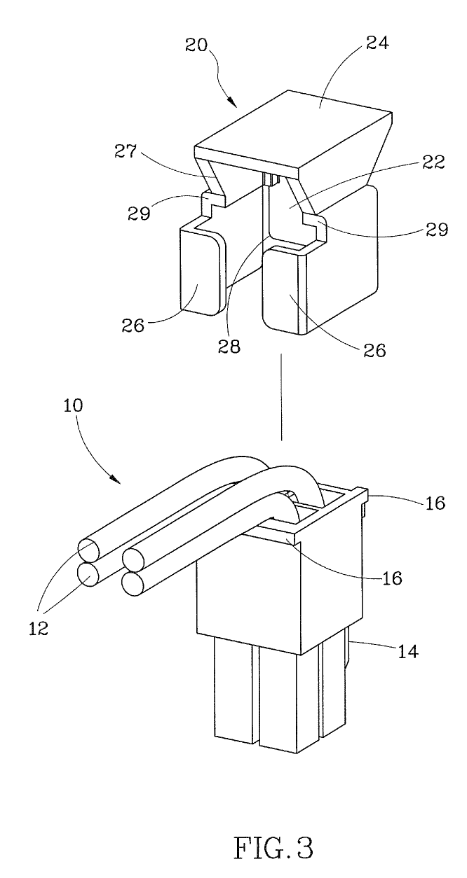

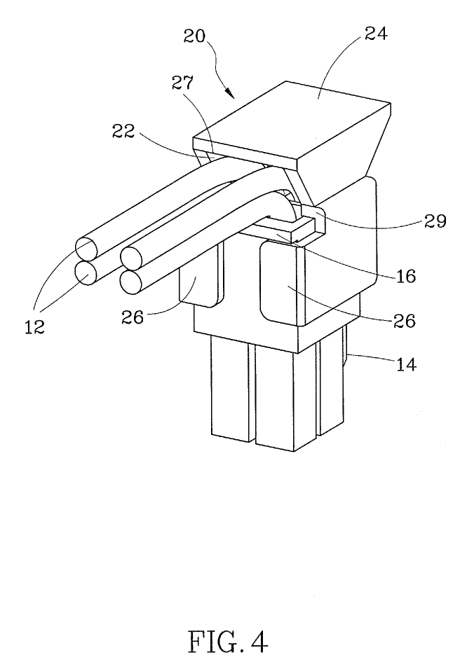

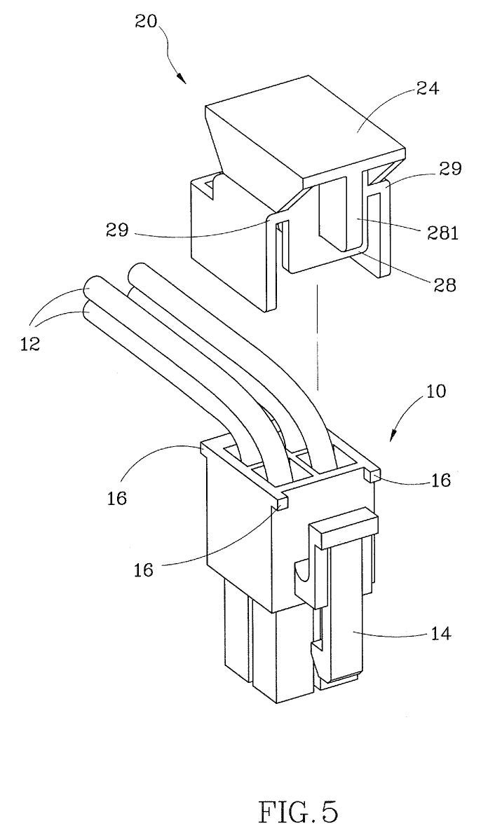

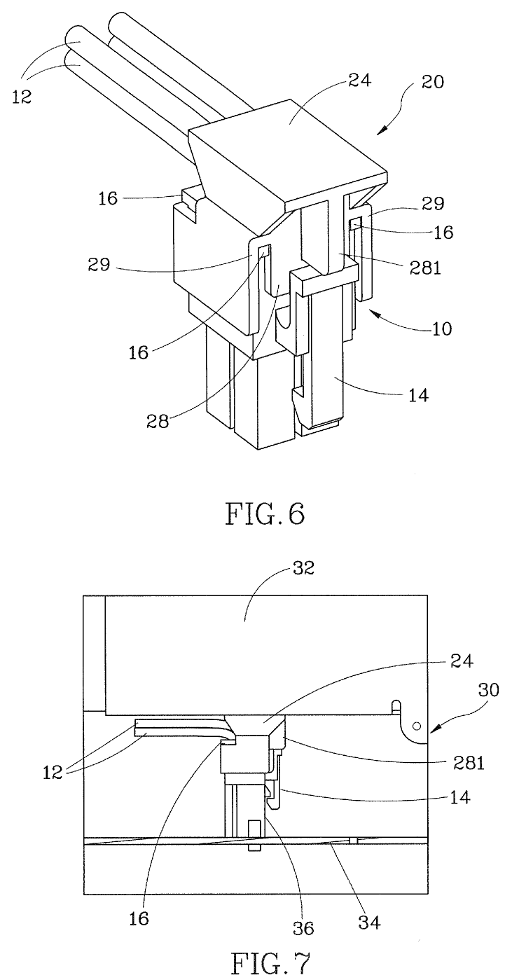

Referring to FIGS. 2-7, an electric wire protector is shown for installation on a connector 10 (see FIG. 3). The connector 10 is connected with four electric wires 12 for transmitting signal or providing power supply. The connector 10 has a clip 14 and two protruding portions 16. The clip 14 is adapted to engage with a electrical power connector 36 of a motherboard 34 (see FIG. 7). The protruding portions 16 are respectively extended from one of the edges of the connector 10. Because this structure of connector 10 is a commercially available design of conventional techniques, no further detailed description in this regard is necessary.

The electric wire protector has a body 20. The body 20 has an accommodation chamber 22, a top 24, at least one, for example, two clamping portions 26, a stop wall 28 and two limiters 29. The accommodation chamber 22 is adapted to accommodate the connector 10. The top 24 is a flat wall provided at the top side of the body 20 for holding the electric wires 12 in a curved status and protecting the electric wires 12 against oppression or stretching by the housing of the electronic implement in which the connector 10 is installed. The clamping portions 26 are provided at a lower side of the body 20 for clamping on the connector 10 to secure the body 20 to the connector 10. An opening 27 is defined between the top 24 and the clamping portions 26 for the passing of the electric wires 12 after installation of the connector 10 in the accommodation chamber 22. The stop wall 28 is adapted to prohibit the clip 14 from a false action or displacement. Further, the stop wall 28 has a rib 281 that is stopped against the clip 14 at the top side thereof to prohibit the clip 14 from displacement. The limiter 29 is disposed at the middle part of the body 20, and bilaterally curved outwards from the bottom side of the top 24.

When in use, the stop wall 28 of the body 20 is aimed at the gap between the outside wall of the connector 10 and the clip 14, and then the body 20 is lowered and capped on the connector 10 to force the clamping portions 26 into engagement with the protruding portions 16 of the connector 10. At this time, the limiters 29 are stopped by the top sides of the connector 10 to prohibit displacement of the body 20 relative to the connector 10. The rib 281 is stopped against the clip 14 at the top side to prohibit the clip 14 from a false action or displacement. Thus, the installation of the electric wire protector is done.

Referring to FIG. 7, the connector 10 that is capped by the electric wire protector of the present invention is electrically connected to an electrical power connector 36 on a motherboard 34 inside a housing 30 of an electronic implement. The housing 30 comprises a cover member 32 for closing the housing 30.

As illustrated, the top 24 of the body 20 is stopped against the cover member 32 when the housing 30 is closed. The electric wire protector provides a sufficient space for the passing of the electric wires 12 to prohibit the cover member 32 from oppressing the electric wires 12. Therefore, the electric wires 12 do not interfere with the cover member 32 such that the cover member 32 can be well protected by the electric wire protector. Further, as shown in FIG. 7, the rib 281 transfers the pressure from the cover member 32 to the clip 14, holding the clip 14 in positive engagement with the electrical power connector 36. Therefore, the electric wire protector prohibits the connector 10 from a false action.

As stated above, the electric wire protector of the present invention prohibits interference between the electric wires and the housing of the electronic implement, preventing stretching of the electric wires by the cover member of the electronic implement, i.e., preventing contact carbonization, or a short circuit or spark. Therefore, the invention effectively protects the electric wires, assuring safety use of the electric wires and prohibiting the connector from a false action.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An electric wire protector for capping on an connector connected to at least one electric wire, the electric wire protector comprising a body defining an accommodation chamber for accommodating said connector and for the passing of the at least one electric wire, and at least one clamping portion extending from a lower side of said body for clamping on said connector to secure said body to said connector; wherein said body has a top for stopping at the electric wires for holding the electric wires in a curved manner.

2. The electric wire protector as claimed in claim 1, wherein said body has a stop wall for stopping against a clip of said connector to prohibit the clip of said connector from displacement.

3. The electric wire protector as claimed in claim 2, wherein said stop wall has a rib for stopping at a top side of the clip of said connector.

4. The electric wire protector as claimed in claim 1, wherein said body has at least one limiter on a middle part thereof for stopping at a top side of said connector to limit the mounting depth of said body on said connector.

5. The electric wire protector as claimed in claim 1, wherein said at least one clamping portion is adapted to clamp on at least one protruding portion of said connector.
